(19) United States
(12) Patent Application Publication
(10) Pub. No.: US 2011/0181744 A1
(43) Pub. Date: Jul. 28, 2011

(54) IMAGING APPARATUS AND METHOD FOR CONTROLLING IMAGE COMPRESSION RATIO OF THE SAME

(75) Inventors: Masahiro HOJO, Osaka (JP); Masahiro Ogawa, Osaka (JP); Tomokazu Uchida, Osaka (JP)

(73) Assignee: PANASONIC CORPORATION, Osaka (JP)

(21) Appl. No.: 13/080,411

(22) Filed: Apr. 5, 2011

Related U.S. Application Data
(63) Continuation of application No. PCT/JP2009/004736, filed on Sep. 18, 2009.

(30) Foreign Application Priority Data
Nov. 18, 2008 (JP) 2008-294459

(51) Int. Cl. H04N 5/228

(52) U.S. Cl. 348/208.12; 348/E05.024

(57) ABSTRACT

When an input image is received from an imaging element, a detection circuit detects frequency information of the input image, and an electronic shake processing circuit detects shake information (motion amount) of the input image. A CPU receives the frequency information and the shake information via an image processing circuit. The CPU increases a compression ratio of the input image when high frequency components are dominant, and decreases the compression ratio when low frequency components are dominant. The CPU also increases the compression ratio when the input image is moving, and decreases the compression ratio when the input image is not moving. A compression/decompression circuit compresses the image based on the compression ratio thus set.

### CROSS-REFERENCE TO RELATED APPLICATIONS

This is a continuation of PCT International Application PCT/JP2009/004736 filed on Sep. 18, 2009, which claims priority to Japanese Patent Application No. 2008-294459 filed on Nov. 18, 2008. The disclosures of these applications including the specifications, the drawings, and the claims are hereby incorporated by reference in their entirety.

### BACKGROUND

The present disclosure relates to imaging apparatuses including image compression circuits, and methods for controlling the image compression ratios of imaging apparatuses.

Mobile terminals equipped with built-in cameras as well as apparatuses dedicated to capturing images, such as digital still cameras, digital camcorders, etc., have come into widespread use. These imaging apparatuses employ image data compression techniques, such as the joint photographic experts group (JPEG), the moving picture experts group (MPEG), etc. Note that when an input image is compressed to a predetermined data size in a stepwise manner, it takes a longer time to complete the compression process, and it is necessary to provide a memory having a large capacity to hold all data of the original image.

Therefore, there is a conventional technique of estimating the number of bytes of data which will be obtained by compressing an input image, based on high and low frequency components in the horizontal direction of the input image and high and low frequency components in the vertical direction of the input image, and based on the estimated number of bytes, calculates a compression ratio which allows the input image to be compressed at a time (see Japanese Patent Publication No. 2006-13570.

### SUMMARY

In the above conventional technique, there is a problem that, for example, when the lens of an imaging apparatus is moved from a scene where high frequency components are dominant to a scene where low frequency components are dominant, the image compression ratio is no longer appropriate, resulting in a degradation in image quality.

An example imaging apparatus includes an imaging element, a section configured to detect frequency information of an input image obtained from the imaging element, a section configured to detect shake information from the imaging element, a section configured to set a compression ratio of the input image based on the frequency information of the input image and the shake information, and a section configured to compress the input image based on the compression ratio.

With this configuration, even when the lens of an imaging apparatus is moved from a scene where high frequency components are dominant to a scene where low frequency components are dominant, an appropriate image compression ratio is set, whereby a degradation in image quality can be reduced or prevented.

According to the present invention, the compression ratio of an input image is set using frequency information of the input image and shake information, whereby a degradation in an image is advantageously reduced or prevented even in a scene in which the image is degraded in the conventional art.

### BRIEF DESCRIPTION OF THE DRAWINGS

FIG. 1 is a block diagram showing a configuration of an imaging apparatus according to an embodiment of the present invention.

FIG. 2 is a diagram showing example designated positions of detection blocks and shake blocks in an input image to the imaging apparatus of FIG. 1.

FIG. 3 is a flowchart showing operation of obtaining frequency information of an input image in the imaging apparatus of FIG. 1.

FIG. 4 is a flowchart showing operation of obtaining shake information in the imaging apparatus of FIG. 1.

FIG. 5 is a flowchart showing an image compression ratio control method in the imaging apparatus of FIG. 1.

FIG. 6 is a flowchart showing another image compression ratio control method in the imaging apparatus of FIG. 1.

### DETAILED DESCRIPTION

Embodiments of the present invention will be described with reference to the accompanying drawings.

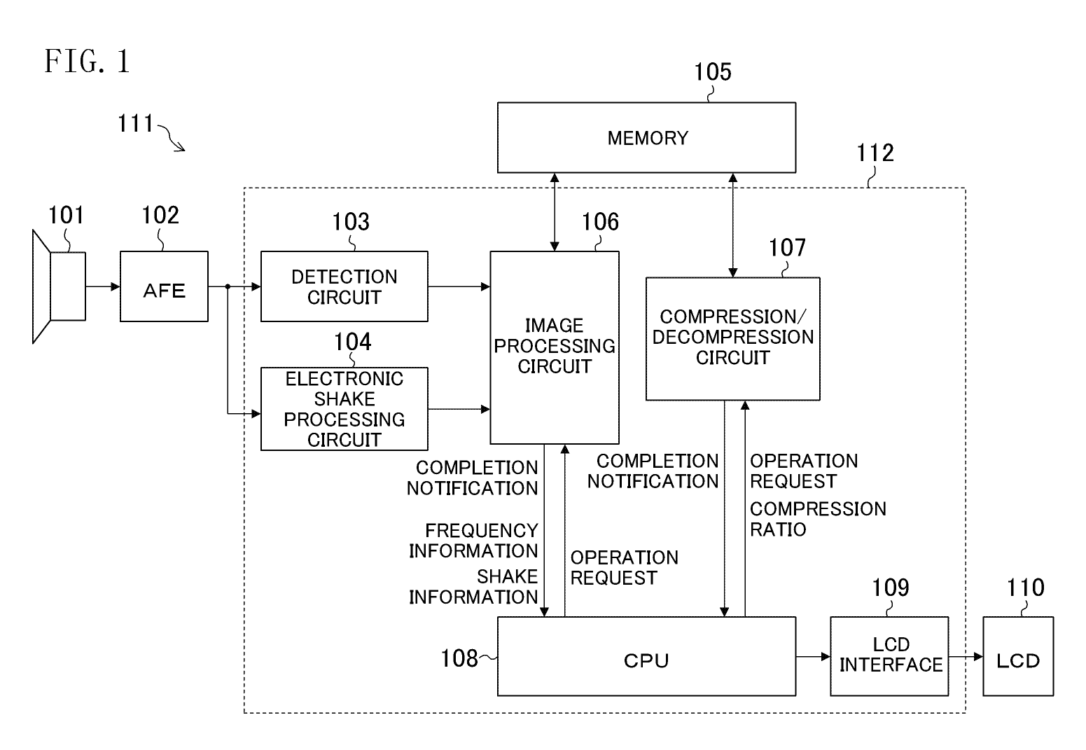

FIG. 1 is a block diagram showing a configuration of an imaging apparatus according to an embodiment of the present invention. The imaging apparatus 111 of FIG. 1 includes an imaging element 101 which receives an image, an analog front end (AFE) 102 which converts an analog signal into a digital signal, an image processing large-scale integrated circuit (LSI) 112, a memory 105 which accumulates image information etc., and a liquid crystal display (LCD) 110 which displays an image. The image processing LSI 112 includes a detection circuit 103, an electronic shake processing circuit 104, an image processing circuit 106, a compression/decompression circuit 107 which compresses and decompresses an image using JPEG, MPEG, etc., a central processing unit (CPU) 108 which controls the entire system, and an LCD interface 109 which is used for a display control.

The CPU 108 sends an operation request to the image processing circuit 106, and receives a completion notification, frequency information of an input image, and shake information from the image processing circuit 106. The CPU 108 also sends an operation request and a compression ratio to the compression/decompression circuit 107, and receives a completion notification from the compression/decompression circuit 107.

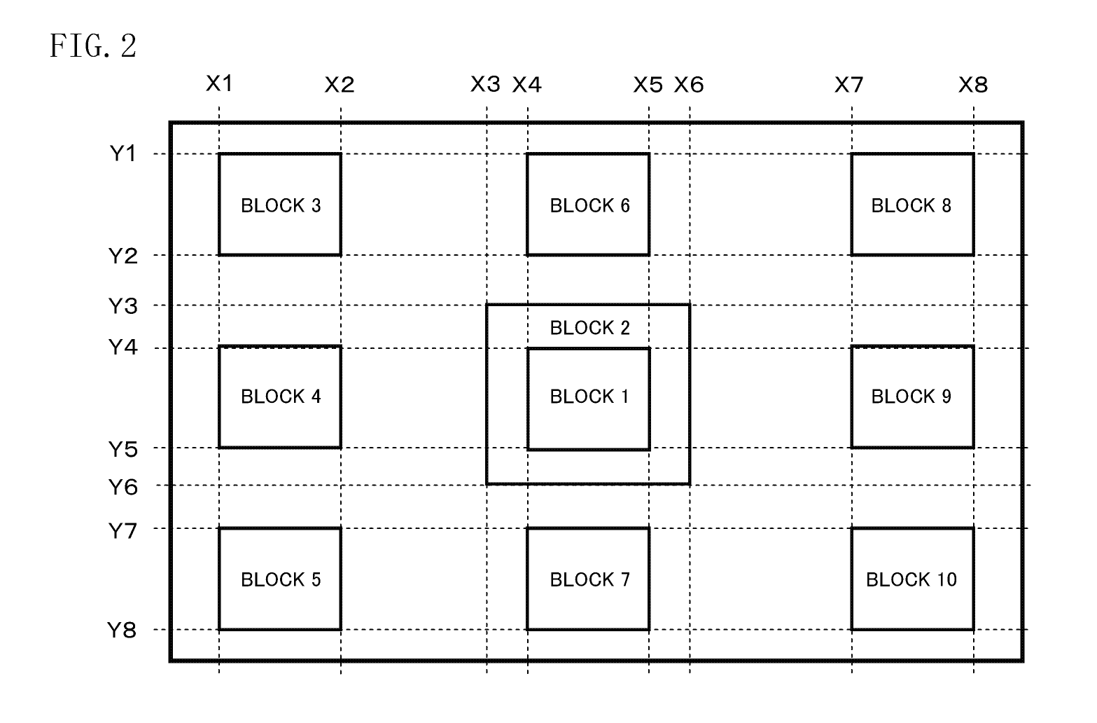

FIG. 2 shows example designated positions of detection blocks for obtaining frequency information and shake blocks for obtaining shake information in an input image to the imaging apparatus 111 of FIG. 1. For example, the position of a block 3 which serves as a detection block and a shake block, is decided by specified coordinate values X1, X2, Y1, and Y2 of FIG. 2. The positions of other blocks 1, 2, and 4-10 are each similarly decided by the corresponding two of specified horizontal coordinate values X1-X8 and the corresponding two of specified vertical coordinate values Y1-Y8.

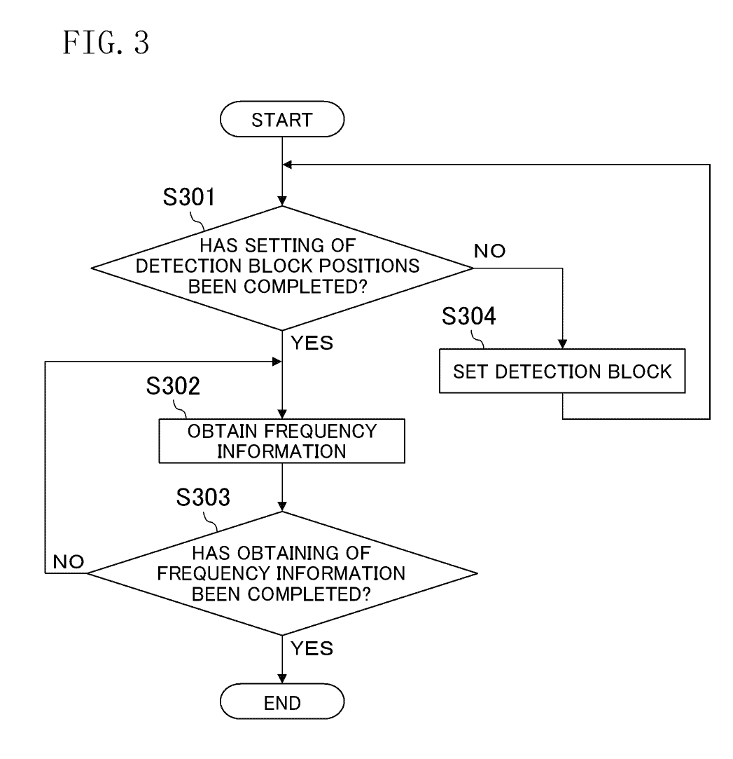

FIG. 3 is a flowchart showing how the CPU 108 operates to obtain the frequency information of an input image in the imaging apparatus 111 of FIG. 1. As shown in FIG. 3, in S301, it is determined whether or not the positions of detection blocks have been designated. If the determination in S301 is negative, the CPU 108 designates the positions of detection blocks as shown in FIG. 2 with respect to the detection circuit 103 in S304. The detection circuit 103 detects the input image on a detection block-by-detection block basis. In the loop of S302 and S303, the CPU 108 obtains the frequency information detected by the detection circuit 103, via the image processing circuit 106. Note that the frequency information of an input image may be obtained on a frame-by-frame basis.

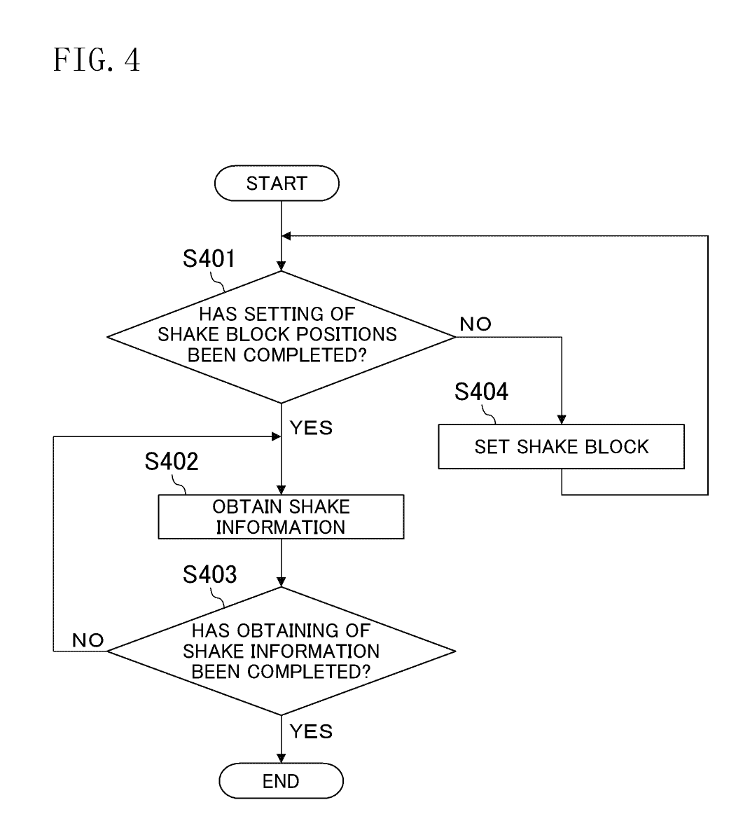

FIG. 4 is a flowchart showing how the CPU 108 operates to obtain shake information in the imaging apparatus 111 of FIG. 1. As shown in FIG. 4, in S401, it is determined whether or not the positions of shake blocks have been designated. If the determination in S401 is negative, the CPU 108 designates the positions of shake blocks as shown in FIG. 2 with respect to the electronic shake processing circuit 104 in S404. The electronic shake processing circuit 104 detects the shake information (motion amount) of an input image on a shake block-by-shake block basis. In the loop of S402 and S403, the CPU 108 obtains the shake information detected by the electronic shake processing circuit 104, via the image processing circuit 106. Note that the shake information of an input image may be obtained on a frame-by-frame basis.

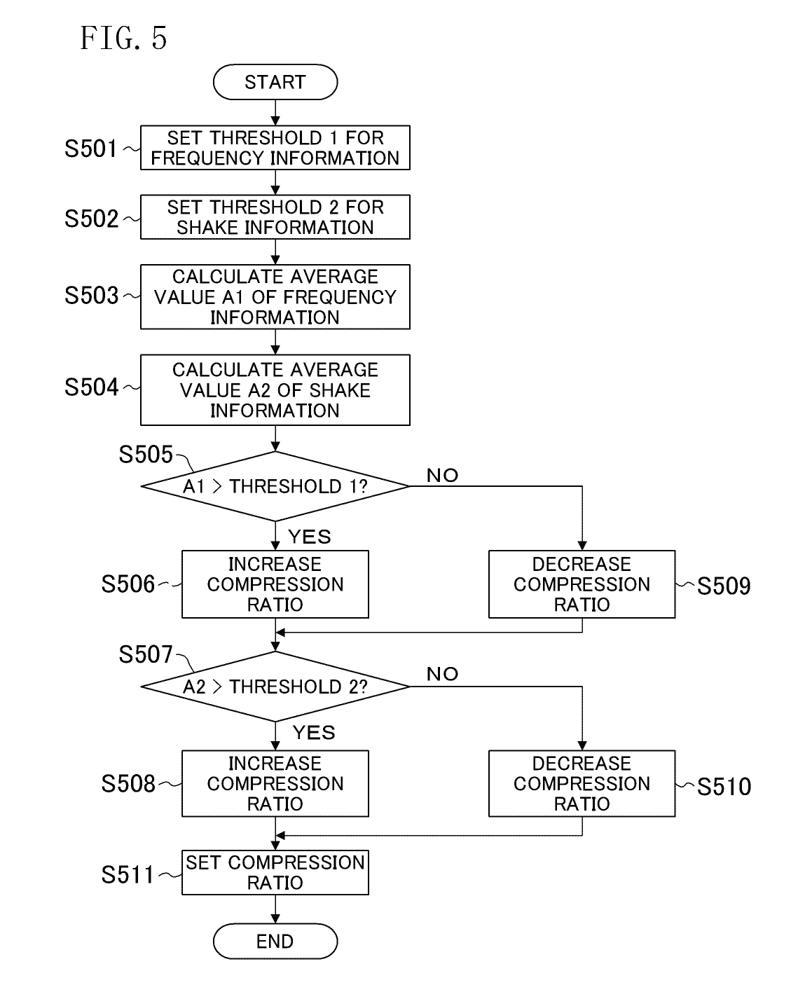

FIG. 5 is a flowchart showing an image compression ratio control method performed by the CPU 108 of FIG. 1. Initially, in S501, a “threshold 1” is set which is to be compared with the obtained frequency information. In S502, a “threshold 2” is set which is to be compared with the obtained shake information. Thereafter, in S503, an average value A1 of the frequency information of the detection blocks 1-10 of FIG. 2 is calculated. In S504, an average value A2 of the shake information of the shake blocks 1-10 of FIG. 2 is calculated.

In S505, the average value A1 of the frequency information calculated in S503 is compared with the threshold 1 set in S501. If the average value A1 of the frequency information is greater than the threshold 1, it is determined that high frequency components are dominant in the input image, and control proceeds to S506, in which the image compression ratio is increased. If the average value A1 of the frequency information is smaller than the threshold 1, it is determined that low frequency components are dominant in the input image, and control proceeds to S509, in which the image compression ratio is decreased. In other words, by utilizing a feature of human visual perception that the human visual system is less sensitive to high frequency components and more sensitive to low frequency components, the compression ratio is increased when high frequency components are dominant and decreased when low frequency components are dominant, thereby reducing or preventing perception of a degradation in image quality while improving encoding efficiency.

Moreover, in S507, the average value A2 of the shake information calculated in S504 is compared with the threshold 2 set in S502. If the average value A2 of the shake information is greater than the threshold 2, it is determined that the input image is moving, and control proceeds to S508, in which the image compression ratio is increased. When the average value A2 of the shake information is smaller than the threshold 2, it is determined that the input image is not moving, and control proceeds to S510, in which the image compression ratio is decreased. In other words, if the input image is moving, the image is smoothed by increasing the compression ratio.

Finally, in S511, the compression ratio which is to be sent from the CPU 108 to the compression/decompression circuit 107 is set. The compression/decompression circuit 107 compresses the input image based on the compression ratio specified by the CPU 108, and stores the result into the memory 105.

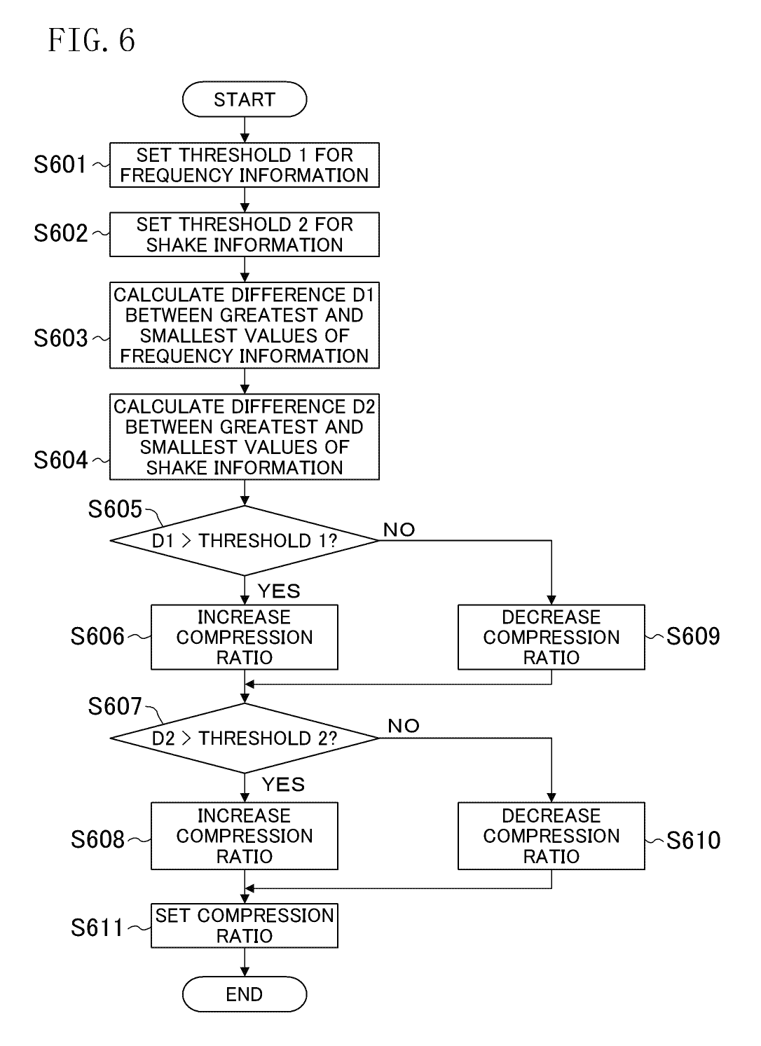

FIG. 6 is a flowchart showing another image compression ratio control method performed by the CPU 108 of FIG. 1. Initially, in S601, a “threshold 1” is set which is to be compared with the obtained frequency information. In S602, a “threshold 2” is set which is to be compared with the obtained shake information. Thereafter, in S603, a difference value D1 between a greatest value and a smallest value of the frequency information is calculated on a detection block-by-detection block basis. In S604, a difference value D2 between a greatest value and a smallest value of the shake information is calculated in a shake block-by-shake block basis.

In S605, the difference value D1 between the greatest and smallest values of the frequency information calculated in S603 is compared with the threshold 1 set in S601. When the difference value D1 between the greatest and smallest values of the frequency information is greater than the threshold 1, it is determined that high frequency components are dominant in the input image, and control proceeds to S606, in which the image compression ratio is increased. When the difference value D1 between the greatest and smallest values of the frequency information is smaller than the threshold 1, it is determined that low frequency components are dominant in the input image, and control proceeds to S609, in which the image compression ratio is decreased.

Moreover, in S607, the difference value D2 between the greatest and smallest values of the shake information calculated in S604 is compared with the threshold 2 set in S602. When the difference value D2 between the greatest and smallest values of the shake information is greater than the threshold 2, it is determined that the input image is moving, and control proceeds to S608, in which the image compression ratio is increased. When the difference value D2 between the greatest and smallest values of the shake information is smaller than the threshold 2, it is determined that the input image is not moving, and control proceeds to S610, in which the image compression ratio is decreased.

Finally, in S611, the compression ratio which is to be sent from the CPU 108 to the compression/decompression circuit 107 is set. The compression/decompression circuit 107 compresses the input image based on the compression ratio specified by the CPU 108, and stores the result into the memory 105.

Although, in the example of FIG. 6, the difference value D1 between the greatest and smallest values of the frequency information is used to determine whether dominant frequency components are high or low, only the greatest value of the frequency information or only the smallest value of the frequency information may be used.

Also, although, in the example of FIG. 6, the difference value D2 between the greatest and smallest values of the shake information is used to determine whether the motion amount is large or small, only the greatest value of the shake information or only the smallest value of the shake information may be used.

As described above, the imaging apparatus of the present invention has the advantage of compressing an image with high accuracy without increasing cost, and is useful for digital cameras etc.

What is claimed is:

1. An imaging apparatus comprising:
an imaging element;
a section configured to detect frequency information of an input image obtained from the imaging element;
a section configured to detect shake information from the imaging element;
a section configured to set a compression ratio of the input image based on the frequency information of the input image and the shake information; and
a section configured to compress the input image based on the compression ratio.

2. The imaging apparatus of claim 1, wherein
the frequency information of the input image is obtained on a detection block-by-detection block basis.

3. The imaging apparatus of claim 1, wherein
the shake information is obtained on a shake block-by-shake block basis.

4. The imaging apparatus of claim 1, wherein
the frequency information of the input image is obtained on a frame-by-frame basis.

5. The imaging apparatus of claim 1, wherein
the shake information is obtained on a frame-by-frame basis.

6. The imaging apparatus of claim 2, wherein
the compression ratio of the input image is set based on an average value of the frequency information obtained on a detection block-by-detection block basis.

7. The imaging apparatus of claim 3, wherein
the compression ratio of the input image is set based on an average value of the shake information obtained on a shake block-by-shake block basis.

8. The imaging apparatus of claim 6, wherein
the compression ratio of the input image is set based on the average value of the frequency information obtained on a detection block-by-detection block basis and an average value of the shake information obtained on a shake block-by-shake block basis.

9. The imaging apparatus of claim 2, wherein
the compression ratio of the input image is set based on a greatest value of the frequency information obtained on a detection block-by-detection block basis.

10. The imaging apparatus of claim 3, wherein
the compression ratio of the input image is set based on a greatest value of the shake information obtained on a shake block-by-shake block basis.

11. The imaging apparatus of claim 9, wherein
the compression ratio of the input image is set based on the greatest value of the frequency information obtained on a detection block-by-detection block basis, and a greatest value of the shake information obtained on a shake block-by-shake block basis.

12. The imaging apparatus of claim 2, wherein
the compression ratio of the input image is set based on a smallest value of the frequency information obtained on a detection block-by-detection block basis.

13. The imaging apparatus of claim 3, wherein
the compression ratio of the input image is set based on a smallest value of the shake information obtained on a shake block-by-shake block basis.

14. The imaging apparatus of claim 12, wherein
the compression ratio of the input image is set based on the smallest value of the frequency information obtained on a detection block-by-detection block basis, and a smallest value of the shake information obtained on a shake block-by-shake block basis.

15. The imaging apparatus of claim 2, wherein
the compression ratio of the input image is set based on a difference value between a greatest value and a smallest value of the frequency information obtained on a detection block-by-detection block basis.

16. The imaging apparatus of claim 3, wherein
the compression ratio of the input image is set based on a difference value between a greatest value and a smallest value of the shake information obtained on a shake block-by-shake block basis.

17. The imaging apparatus of claim 15, wherein
the compression ratio of the input image is set based on the difference value between the greatest value and the smallest value of the frequency information obtained on a detection block-by-detection block basis, and a difference value between a greatest value and a smallest value of the shake information obtained on a shake block-by-shake block basis.

18. A method for controlling an image compression ratio of an imaging apparatus, comprising the steps of:
detecting frequency information of an input image obtained from an imaging element;
detecting shake information from the imaging element;
setting a compression ratio of the input image based on the frequency information of the input image and the shake information; and
compressing the input image based on the compression ratio.
